(19) United States
(12) Patent Application Publication
(10) Pub. No.: US 2013/0028278 A1
(43) Pub. Date: Jan. 31, 2013

(54) OPTICAL TRANSMITTER FOR STABILIZING OUTPUT WAVELENGTH

(71) Applicant: Shogo AMARI, Yokohama (JP)

(72) Inventor: Shogo AMARI, Yokohama (JP)

(73) Assignee: SUMITOMO ELECTRIC INDUSTRIES, LTD., Osaka (JP)

(21) Appl. No.: 13/558,868

(22) Filed: Jul. 26, 2012

(30) Foreign Application Priority Data
Jul. 28, 2011 (JP) 2011-165726

(51) Int. Cl. H01S 3/04

(52) U.S. Cl. 372/34

(57) ABSTRACT

An optical transmitter implemented with an LD whose temperature is stably controlled is disclosed. A temperature of the LD is continuously monitored; and a difference from the target temperature and a time derivative thereof are calculated. When the time derivative becomes substantially zero, that is, the difference becomes an extremum, the convergent range for the time derivative is changed depending on the extremum, or an average of the current extremum and the previous extremum.

### BACKGROUND OF THE INVENTION

1. Field of the Invention

The present invention relates to an optical transmitter, in particular, the invention relates to stabilize the output wavelength thereof.

2. Related Background Arts

The United States patent, U.S. Pat. No. 7,535,940, has disclosed an optical transmitter in which the optical transmitter may output signal light after a temperature of a semiconductor laser diode (hereafter denoted as LD) becomes stable.

### SUMMARY OF THE INVENTION

One aspect of one of embodiments of the present invention relates to a method to control an optical transmitter that includes an LD, a temperature of which is periodically monitored then controlled by a thermo-electric-cooler (TEC). The method of the embodiment includes steps of calculating a difference of the monitored temperature of the LD from a target temperature of the LD, and also calculating a time derivative of the difference at every monitoring. One of features of the method is that, when the difference has an extremum at one of monitors, the method varies a second convergent range depending on the difference of the temperatures, and activates the LD when the difference of the temperatures stays within a first convergent range and the time derivative of the difference stays within the second convergent range each concurrently for a preset period.

The step of varying the second convergent range includes steps of: calculating an average of a current extremum of the difference between two temperatures above and a previous extremum of the difference, and varying the second convergent range according to the average. For instance, the second convergent range inversely depends on the average. In an alternate, the step of varying the second convergent range includes steps of: first determining whether a current extremum has an absolute greater than an absolute of a previous extremum, and, when the current extremum is greater than the previous extremum, varying the second convergent range to depend inversely on the current extremum.

Another aspect of the embodiments of the present invention relates to an optical transmitter that includes an LD and a controller. The controller of the embodiment is configured to calculate a difference of a temperature of the LD from a target temperature, and to calculate a time derivative of the difference. The controller activates the LD until the difference and the time derivative thereof concurrently stay within the first convergent range and the second convergent range, respectively. A feature of the optical transmitter of the embodiment is that the second convergent range for the time derivative of the difference between two temperatures is dynamically varied depending on an extremum of the difference between two temperatures.

The controller traces the difference between two temperatures and calculate an average of a current extremum and a previous extremum thereof; and vary the second convergent range so as to depend inversely on the average of two extrema. In a modification, the controller determines whether the current extremum is greater than the previous extremum, and, when the current extremum is greater than the previous one, the controller varys the second convergent range to depend inversely on the current extremum.

### BRIEF DESCRIPTION OF THE DRAWINGS

The foregoing and other purposes, aspects and advantages will be better understood from the following detailed description of a preferred embodiment of the invention with reference to the drawings, in which:

FIG. 1 shows a functional block diagram of the optical transmitter according to an embodiment of the invention;

FIG. 2 illustrates an example of a difference between the current temperature of the LD and the target temperature, and the time derivative thereof;

FIG. 3 is an example of the look-up-table (LUT) that stores a series of the second convergent ranges against the average of the current extremum and the previous extremum of the difference;

FIG. 4A shows a behavior of the difference, where a plurality of averages xₐᵥₑ of previous two extrema are denoted by filled circles, FIG. 4B shows a time derivative thereof where the dynamically settable second convergent range are denoted by bold broken lines, and FIG. 4C shows a behavior of the flag Tx_ENABLE;

FIG. 5 shows a flow chart to set the second convergent range for the time derivative of the temperature difference; and

FIGS. 6A to 6C shows behaviors of the temperature difference, the time derivative thereof, and the flag Tx_ENABLE, where they are copied from FIGS. 4A to 4C, but FIG. 6A denotes extrema alternately selected to set the second convergent range in FIG. 6B by filled circles.

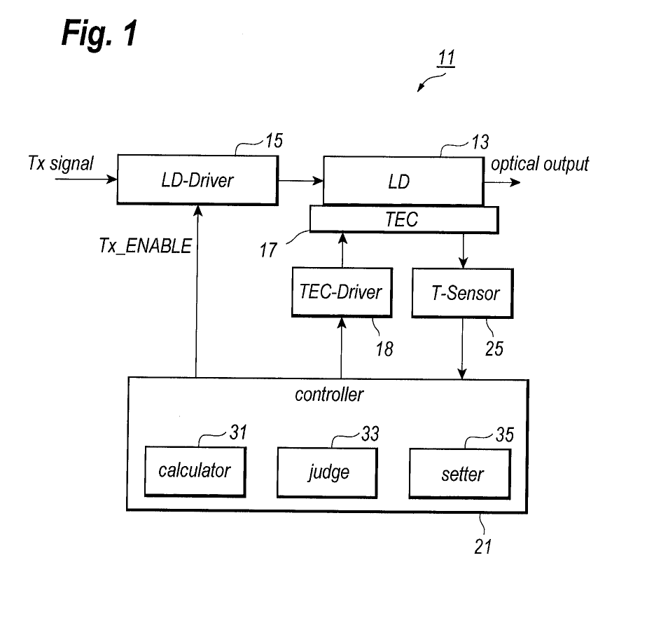

### DESCRIPTION OF PREFERRED EMBODIMENTS

Next, some preferred embodiments according to the present invention will be described as referring to the drawings. In the description of the drawings, the numerals or symbols same or similar to each other will refer to the elements same or similar to each other without overlapping explanations.

An optical transmitter 11 according to an embodiment of the invention includes an LD 13, an LD-Driver 15, a TEC 17, a TEC-Driver 18, a controller 21, and a temperature sensor 25. The LD 13 is a type of the Fabry-Perot, the distributed feedback (DFB), and/or the vertical cavity surface emitting LD (VCSEL). The LD-Driver 15 electrically drives the LD 13, and the LD 13 emits signal light responding to the electrical signal provided from the LD-Driver 15. The TEC 17 controls a temperature of the LD 13 driven by the TEC-Driver 18. The temperature sensor 26, which monitors the temperature of the LD 13, generates a monitored signal and transmits it to the controller 21.

The controller 21, which accesses a memory (not shown in the figures) that stores a target temperature of the LD 13, controls the TEC-Driver 18. Specifically, the controller 21 calculates a difference between the target temperature of the LD 13 held and a monitored signal provided from the temperature sensor 25. The TEC-Driver 18 drives the TEC 17 so as to reduce the difference of two temperatures. Also, the controller 21 outputs a flag Tx_ENABLE to the LD-Driver, which activates the LD-Driver 15.

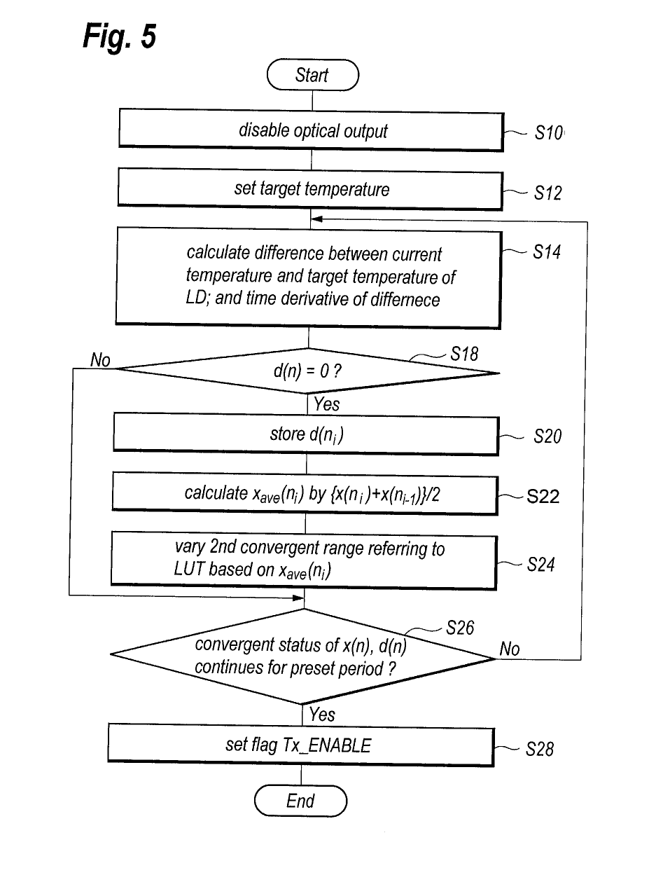

The controller 21 includes a central processing unit (CPU), some read only memories (ROM), some random access memories (RAM), and so on. The controller 21 comprehensively controls the optical transmitter 11 by the CPU based on the program temporally loaded in the RAM. Thus, the CPU in the controller 17 has various functions depending on the programs, that is, the controller 21 functionally includes a calculator 31, a judge 33, and a setter 35. Also, the ROM holds a look-up-table, an arrangement of which will be shown in FIG. 3. The controller 21 carries out the procedure shown in the flowchart of FIG. 5 by the calculator 31, the judge 33, and the setter 35 as referring to the look-up-table in the ROM.

Specifically, the calculator 31 not only calculates a difference between the monitored signal provided from the temperature sensor 25, which corresponds to the current temperature of the LD 13, and the target temperature but evaluates a convergence of the difference and a time derivative of the difference. The convergence is a final value to which the difference between the sensed temperature and the target temperature converges, which will be explained later in the specification.

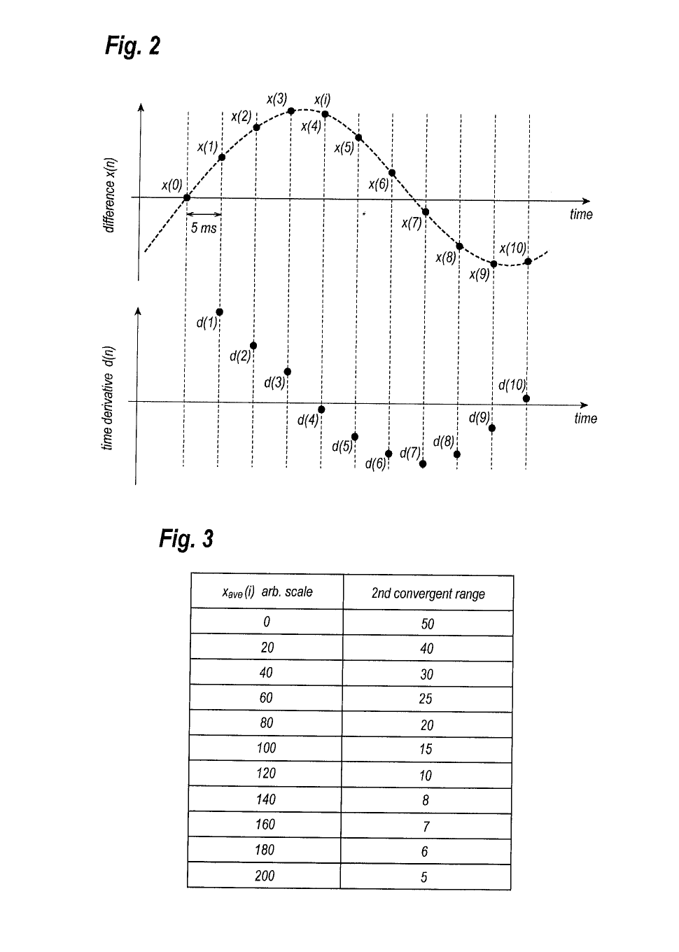

Further specifically, the calculator 31 periodically samples the difference as shown in FIG. 2, where x(n) corresponds to the difference between two temperatures at the n-th monitoring, where n is an integer greater than zero; and d(n) corresponds to a time derivative of the difference at the n-th monitoring, which may be a value of the n-th difference subtracted by the difference sampled in the previous monitoring. Assuming the period between the samplings is 5 milli-seconds (msec), the time derivative d(n) may be calculated by:

d(n)=(x(n)−x(n−1))/5 (1).

The calculator 31 further evaluates an instant at which the time derivative d(n) becomes substantially zero, or the difference x(n) becomes an extremum, maximum or a minimum, and hold a difference x(nᵢ) as a current extremum where the time derivative becomes substantially zero. The calculator 31 estimates the convergence xₐᵥₑ(nᵢ) by a relation of:

xₐᵥₑ(nᵢ)=(x(nᵢ₋₁)+x(nᵢ))/2 (2),

where x(nᵢ₋₁) is the previous minimum or maximum appeared in the difference. That is, xₐᵥₑ(nᵢ) becomes an average of two local extrema successively observed in the difference.

The judge 33, receiving the difference x(n) and the time derivative d(n) thereof from the calculator 31, may determine whether the difference x(n) is within a first convergent range and the time derivative d(n) is within a second convergent range. When the difference x(n) and the time derivative d(n) are both within respective ranges for a preset period, the judge 33 sets the flag Tx_ENABLE and sends it to the LD-Driver 15.

The setter 35 may revise the second convergent range synchronous with the calculation of the average xₐᵥₑ (nᵢ) and the time derivative d(nᵢ). Specifically, the setter 35 sets the second convergent range inverse to the average xₐᵥₑ(nᵢ). That is, the second convergent range narrows as the average xₐᵥₑ (nᵢ) increases, or expands as the average xₐᵥₑ(nᵢ) decreases. The relation between the average xₐᵥₑ and the second convergent range is stored in the memory in the form of a look-up-table (LUT) 37.

FIG. 3 shows an example of the look-up-table 37 that relates the absolute of the average |xₐᵥₑ| to the second convergent range. Referring to the LUT 37, the setter 35 dynamically sets the second convergent range. The LUT 37 in FIG. 3 shows four sections each having a liner dependence of the second convergent range against the absolute average |xₐᵥₑ|, that is, the first section from 0 to 40 of the absolute average where the slope is given by −10/20 (=−½), the second section from 40 to 120 where the slope becomes −5/20 (=−¼), the third section from 120 to 140 where the slope is −2/20 (− 1/10), and the forth section over 140 where the slope is −1/20. However, the second convergent range shows a relation of decreasing monotonically as the absolute convergence |xₐᵥₑ| increases. Preferably, the second convergent range shows a relation of the monotonic decrease but have a positive value in the second derivative thereof.

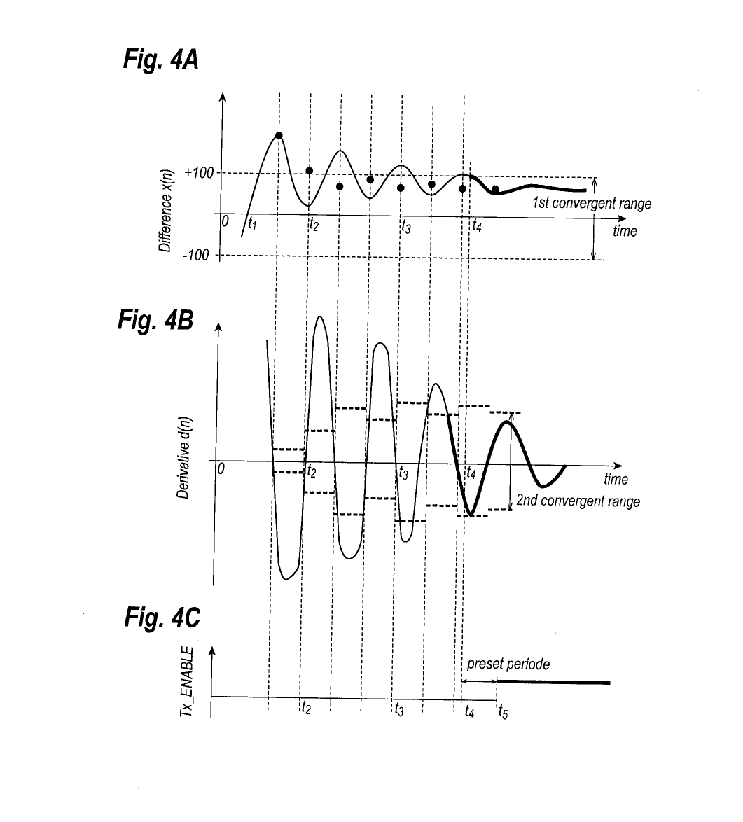

Next, an operation of the optical transmitter 11 thus configured will be described as referring to FIGS. 4 and 5. The description presented below assumes that the time 0 (msec), which means the beginning of the sequence, corresponds to an instant when the optical transmitter 11 is powered on. Powering the optical transmitter 11 at step S10 electrically, the controller 21 first sets a flag Tx_DISABLE to the LD-Driver 15, or negates the flag Tx_ENABLE. Then, the controller 21 sets the target temperature at step S12. Subsequently, the temperature of the LD 13 is continuously sampled with a period of t (msec), which is substantially continuous to calculate the time derivative thereof, and the difference x(n) and the time derivative d(n) thereof are evaluated with this period t at step S14. The period t is, for instance, set in 5 msec.

At step S18, the judge 33 decides whether the time derivative d(n) becomes substantially zero or not. For instance, the time derivative d (t₁) at t₁ is not substantial zero in FIG. 4A, then, the sequence jumps step S18, but, the time derivative shows substantial zero at t₂, then, the sequence advances step S20. At step S20, the difference to x(t₂) of the extremum is stored in the memory, then, the calculator 31 evaluates an average xₐᵥₑ by the equation (2) below between the current extremum of the difference, which is assumed to be x(nᵢ), and the previous extremum defined by x(nᵢ₋₁):

xₐᵥₑ(nᵢ)=[x(nᵢ)+x(nᵢ₋₁)]/2.

Assuming the newest extremum x(nᵢ) of the difference is 20 by an indexed value and the previous extremum is 180 also by the indexed value, then, the average xₐᵥₑ becomes 100. Subsequently, referring to the LUT 37, the second convergent range for the time derivative is revised to be 15/sec by the setter 35 at step S24. The judge 33 judges whether the difference x(n) is within the first convergent range and the time derivative d(n) thereof is within the second convergent range for a preset period. When the judge 33 decides two conditions above mentioned are satisfied, the sequence shown in FIG. 5 advances to step S28.

At the instant t₃, when the difference x(n) becomes an extremum and the second convergent range for the time derivative d(n) is revised at step S24, the sequence shown in FIG. 4 goes back step S14 because the difference x(n) exceeds the first convergent range. On the other, at the instant t₅, where the difference x(n) continues the status within the first convergent range and the time derivative d(n) also continues the status within the second convergent range for the preset period, the judge 33 in the controller 21 activates the LD-Driver 15 by providing the flag Tx_ENABLE.

### Modified Embodiment

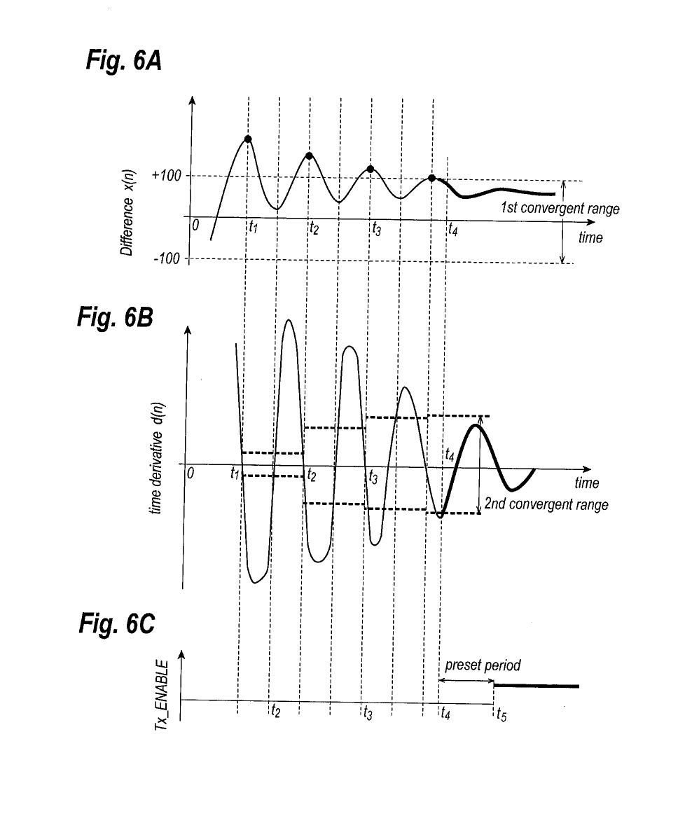

The sequence thus described assumes that an average xₐᵥₑ between the current extremum and the previous extremum is evaluated by the judge 33, and the setter 35 revises the second convergent range for the time derivative based on thus calculated average xₐᵥₑ. However, the judge 33 is unnecessary to calculate the average of the extremum. As shown in FIG. 6, the judge 33 takes extrema alternately, which are denoted by filled circles, each having an absolute greater than an absolute for rest extrema excluded from the evaluation. Specifically, the extremum at t₁ is the first appearance, then, the setter 35 newly sets the second convergent range by referring to the LUT 37 based on the difference x(t₁). The extremum between t₁ and t₂ is closer to the target than the extremum at t₁, which is stored in the controller 21; then, the setter 35 takes no action. The extremum at t₂ is far from the target, at which the difference x(n) is zero, than the previous extremum between t₁ and t₂, then, the setter 35 newly sets the second convergent range based on the extremum x(t₂). Thus, the second convergent range is dynamically varied depending on the extrema. The conditions, where the difference x(n) is within the first convergent range and the time derivative d(n) thereof is within the dynamically varied second convergent range for the preset period, are satisfied at the instant t₅, then the controller 21 sets the flag Tx_ENABLE to the LD-Driver 15.

Thus, the optical transmitter 11 of the embodiments, the calculator 31 evaluates the average xₐᵥₑ between the current extremum and the previous extremum, or determine the extremum far from the target; and the setter 35 dynamically sets the second convergent range for the time derivative d(n) referring to the LUT 37 based on thus evaluated average xₐᵥₑ or the far extremum. The LUT 37 stores a series of the second convergent ranges, where the second convergent range increases as the absolute of the average xₐᵥₑ, or the far extremum, of the difference x(n) decreases.

When the current temperature of the LD 13 is shifted further from the target temperature, the LD 13 is hard to be activated. While, when the current temperature of the LD 13 close to the target temperature, the LD 13 is likely to be activated by widening the second convergent range for the time derivative of the temperature difference, which accelerates the activation of the LD 13.

Moreover, the optical transmitter 11 of the embodiment refers to the LUT 37 for setting the second convergent range dynamically, which simplifies the procedure of the setter 35 in the controller 21. When the setter 35 has an enough capacity, the setter 35 is unnecessary to refer to the LUT 35. The setter 35 calculates the new convergent range for the time derivative at every instant when the difference x(n) becomes an extremum.

While there has been illustrated and described what are presently considered to be example embodiments of the present invention, it will be understood by those skilled in the art that various other modifications may be made, and equivalents may be substituted, without departing from the true scope of the invention. Additionally, many modifications may be made to adapt a particular situation to the teachings of the present invention without departing from the central inventive concept described herein. Therefore, it is intended that the present invention not be limited to the particular embodiments disclosed, but that the invention include all embodiments falling within the scope of the appended claims.

I claim:

1. A method to control an optical transmitter that includes a semiconductor laser diode (LD) whose temperature is periodically monitored and controlled by a thermo-electric cooler (TEC), comprising steps of:
calculating a difference between the monitored temperature of the LD and a target temperature of the LD, and a time derivative of the difference at every monitoring;
when the difference shows an extremum at one of to monitors, varying a second convergent range for the time derivative depending on the difference; and
when the difference stays within a first convergent range and the time derivative stays within the second convergent range each for a preset period, activating the LD.

2. The method of claim 1,
wherein the step of varying the second convergent range includes steps of:
calculating an average of a current extremum of the difference between temperatures and a previous extremum of the difference; and
varying the second convergent range based on the average.

3. The method of claim 2,
wherein the step of varying the second convergent range includes steps of:
widening the second convergent range when the average decreases, or narrowing the second convergent range when the average increases.

4. The method of claim 1,
wherein the step of varying the second convergent range includes steps of:
determining whether a current extremum has an absolute greater than an absolute of a previous extremum, and
varying the second convergent range based on the current extremum when the absolute of the current extremum is greater than the absolute of the previous extremum.

5. The method of claim 4,
where the step of varying the second convergent range includes steps of:
widening the second convergent range when the current extremum decreases, or narrowing the second convergent range when the current extremum increases.

6. An optical transmitter, comprising:
a semiconductor laser diode (LD); and
a controller configured to calculate a difference between a current temperature of the LD and a target temperature of the LD, and to calculate a time derivative of the difference to activate the LD when the difference is within a first convergent range and the time derivative is within a second convergent range each for a preset period,
wherein the controller narrows the second convergent range depending on an extremum of the difference of the temperatures.

7. The optical transmitter of claim 6,
wherein the controller widens the second convergent range when an average of a current extremum and a previous extremum decreases, or narrows the second convergent range when the average increases.

8. The optical transmitter of claim 6,
wherein the controller compares an absolute of a current extremum of the difference with an absolute of a previous extremum of the difference, and
when the absolute of the current extremum of the difference is greater than the absolute of the previous extremum of the difference, widens the second convergent range when the current extremum of the difference decrease compared with an extremum before the previous extremum, or narrows the second convergent range when the current extremum increases compared with an extremum before the previous extremum.

9. The optical transmitter of claim 6,
wherein the controller includes a calculator, a judge, and a setter, the calculator calculating the difference of the current temperature of the LD from the target temperature and the time derivative of the difference, the judge comparing the current extremum with the previous extremum, the setter setting the second convergent range for the time derivative based on the current extremum.

10. The optical transmitter of claim 9,
wherein the controller further includes a look-up-table that stores a relation of the second convergent range against the extremum of the difference.

11. The optical transmitter of claim 10,
wherein the second convergent ranges set in the look-up-table monotonically increases as the extremum in the absolute thereof decreases.

12. The optical transmitter of claim 6,
further including an LD-Driver to driver the LD electrically,
wherein the controller sets a flag Tx_ENABLE provided to the LD-Driver to active the LD.
